(19) United States
(12) Patent Application Publication
(10) Pub. No.: US 2024/0311722 A1
(43) Pub. Date: Sep. 19, 2024

(54) COMPUTERISED SYSTEM AND METHOD FOR INTERPRETING LOCATION DATA OF AT LEAST ONE AGRICULTURAL WORKER, AND COMPUTER PROGRAM

(71) Applicant: APTIMIZ, ANGERS (FR)

(72) Inventors: Armand SACHOT, Le Boupère (FR); Matthieu CARPENTIER, Montivilliers (FR); Simon DENONNAIN, Ferrìère -sur-Beaulieu (FR)

(21) Appl. No.: 18/263,696

(22) PCT Filed: Feb. 1, 2022
(86) PCT No.: PCT/EP2022/052371

§ 371 Date: Jul. 31, 2023

(30) Foreign Application Priority Data
Feb. 1, 2021 (FR) FR2100930

(51) Int. Cl. G06Q 10/0631; G06Q 50/02; G06V 10/82

(52) U.S. Cl. CPC G06Q 10/06316; G06Q 50/02; G06V 10/82

(57) ABSTRACT

A computerised method for interpreting location data of at least one agricultural worker, wherein: a database of agricultural activities is provided, comprising, for each agricultural activity, a schedule including at least two agricultural tasks, each agricultural task being characterised by a location identifier and a position in the schedule, a farm database is provided, the database comprising at least one parcel of agricultural land characterised by a location identifier and a location, temporal zoning data are provided for the at least one agricultural worker, which data are received from a portable electronic communication device of the agricultural worker, and a computerised interpretation module associates the temporal zoning data with an agricultural task using the temporal zoning data and the agricultural activity and farm databases, the computerised interpretation module associating the temporal zoning data with an agricultural task using the temporal zoning data and the agricultural activity and farm databases.

### FIELD OF THE INVENTION

The present invention relates to methods for interpreting agricultural worker location data.

### TECHNOLOGICAL BACKGROUND

In the field of agriculture, broadly understood to include animal husbandry, it is known that a worker spends his working days doing various tasks in different places. However, it is difficult to trace the real activity of the worker, because the means of entering information are not compatible with agricultural work. This results in a lack of information preventing the analysis of the activity, which can have harmful economic consequences on the agricultural exploitation.

Japan seems to have considered this question, and we know for example the document JP 41 708 792 which deals with this question. This document describes the definition of a field from GPS data of the corners of the field. Then, it describes the measurement of the position of a worker by means of a GPS, and the attribution of the position to the presence in a field, by comparison with the coordinates defined for this field. This information is used to fill in the worker's agenda.

In addition, the data is interpreted by a fuzzy logic algorithm, which associates certain measured data, depending on the date, with an agricultural task, for example “planting rice” associated with the fact that it is June, and that the agricultural worker is working at 0.41 m/s, with an efficiency of 5.8 a/h, and a field efficiency of 65%.

In the opinion of the inventors, this realization risks creating a significant error rate in the recognition of tasks. In particular, it makes it necessary to rely on parameters representative of agricultural activity that are complex to determine, such as speed or efficiency, and probably very dependent on the human factor, which suggests that this method would not be suitable for exploitations comprising a wide variety of agricultural activities.

### SUMMARY OF THE INVENTION

Thus, the invention relates to a computerized method for interpreting location data of at least one agricultural worker, in which:
a database of agricultural activities is provided comprising, for each agricultural activity, a schedule of at least two agricultural tasks, each agricultural task being characterized by a place identifier and a position in the schedule,
an agricultural exploitation database is provided, the database comprising at least one agricultural parcel characterized by a place identifier and a location,
providing temporal zoning data of the at least one agricultural worker received from a communicating portable electronic device of the agricultural worker, and
a computerized interpretation module associates said temporal zoning data with an agricultural task by means of said temporal zoning data and said databases of agricultural activities and agricultural exploitation.

Thanks to these provisions, the recognition of an agricultural task is based on a priori knowledge of the agricultural activities including agricultural tasks, which makes it possible to increase the rate of recognition of the agricultural task.

Depending on various aspects, it is possible to provide one and/or the other of the provisions below.

According to one embodiment, the interpretation module applies a classifier relating to the agricultural activities defined for the agricultural exploitation and/or a classifier relating to the agricultural activities defined for a set of agricultural exploitations and, in the case where the two classifiers are applied, the interpretation module selects an agricultural task from the results of the two classifiers.

According to one realization,
one provides temporal zoning data of at least one agricultural machine received from a portable electronic device communicating from the agricultural machine, and
the computerized interpretation module associates the temporal zoning data of the agricultural worker with an agricultural task further using the temporal zoning data of the agricultural machine.

According to one embodiment, the computerized interpretation module associates the agricultural worker's temporal zoning data with an agricultural task by further using weather data relating to the agricultural exploitation obtained from a weather database.

According to one embodiment, the method further comprises updating the database of agricultural activities from at least the interpreted location data.

According to another embodiment, the invention provides a method according to the invention in which the computerized interpretation module associates said temporal zoning data with an agricultural task using said temporal zoning data and said agricultural activity and agricultural exploitation databases according to the following steps:
the computerized interpretation module constructs an image for a determined agricultural parcel from the temporal zoning data and said databases of agricultural activities and agricultural exploitation,
the computerized interpretation module associates the constructed image with an agricultural task carried out in the agricultural parcel using a convolutional neural network.

Preferably, the constructed image comprises a trace formed by the temporal zoning data and at least one geometric primitive parameterized according to the temporal zoning data data and said databases of agricultural activities and agricultural exploitation; at least one intensity of the image being determined from the temporal zoning data and the agricultural activity and exploitation databases.

Preferably, the computerized interpretation module encodes at least one piece of information on one layer of a plurality of layers forming the image, this at least one piece of information being derived from or deduced from temporal zoning data and agricultural activity and exploitation databases,

We can provide that the encoded information is:
the trace formed by the temporal zoning data,
the agricultural parcel determined according to the temporal zoning data and the agricultural exploitation database,
a trace of the agricultural parcel,
a previous task carried out in the determined agricultural parcel,
a time elapsed since the last task performed,
a type of agricultural parcel,
a user using the portable system,
a machine using the portable system,
a weather forecast, or
an activity carried out on other agricultural exploitations.

It may be provided that the computerized interpretation module trains the convolutional neural network with images associated with:
an agricultural task from the database of agricultural activities of an agricultural exploitation of the user or external exploitations,
an agricultural task entered by the user, and/or
an agricultural task previously determined by the interpretation module.

According to another aspect, the invention relates to a computer program comprising program code instructions for the execution of the steps of this method when said program is executed on a computer.

According to another aspect, the invention relates to a computerized system for interpreting location data of at least one agricultural worker comprising a computerized interpretation module suitable for associating temporal zoning data of at least one agricultural worker received from a portable electronic device communicating from the agricultural worker to an agricultural task by means of an agricultural activity database comprising, for each agricultural activity, a schedule of at least two agricultural tasks, each agricultural task being characterized by a place identifier and a position in the schedule and an agricultural exploitation database comprising at least one agricultural parcel characterized by a place identifier and a location.

According to one embodiment, the computerized system further comprises at least one portable electronic communicating device of the agricultural worker adapted to communicate temporal zoning data of the agricultural worker to the computerized interpretation module.

According to one embodiment, the computerized system further comprises a portable electronic device communicating with an agricultural machine suitable for communicating temporal zoning data of the agricultural machine, and the computerized interpretation module is suitable for associating temporal zoning data of the agricultural worker further from the temporal zoning data of the agricultural machine.

### BRIEF DESCRIPTION OF THE DRAWINGS

Embodiments of the invention will be described below with reference to the drawings, briefly described below:

FIG. 1 shows a top view of a cartography of an agricultural exploitation.

FIG. 2 is a “smartphone” screenshot showing the user system at rest.

FIG. 3 represents a same “smartphone” screenshot showing the active user system.

FIG. 4 represents a first screen of the supervision interface.

FIG. 5 presents a second screen of the supervision interface.

FIG. 6 schematically represents a system according to one embodiment of the invention.

FIG. 7 schematically represents a data processing architecture according to one embodiment.

FIG. 8 and FIG. 9 shows examples of images created by the computerized interpretation module.

FIG. 10 represents an example of results of classification of an agricultural task by the computerized interpretation module during the training phase of the convolutional neural network.

FIG. 11 represents an example of results of classification of an agricultural task by the computerized interpretation module once the convolutional neural network has been trained

FIG. 12 represents a second screen of results of association of temporal zoning data with an agricultural task

FIG. 13 represents an example of temporal zoning data collected and interpreted into an agricultural task.

In the drawings, identical references designate identical or similar objects.

### DETAILED DESCRIPTION

### Definitions

“Agricultural” means any activity relating to the cultivation of plants or the raising of animals, including forestry, oyster farming, myciculture, shellfish farming, mussel farming, or heliciculture.

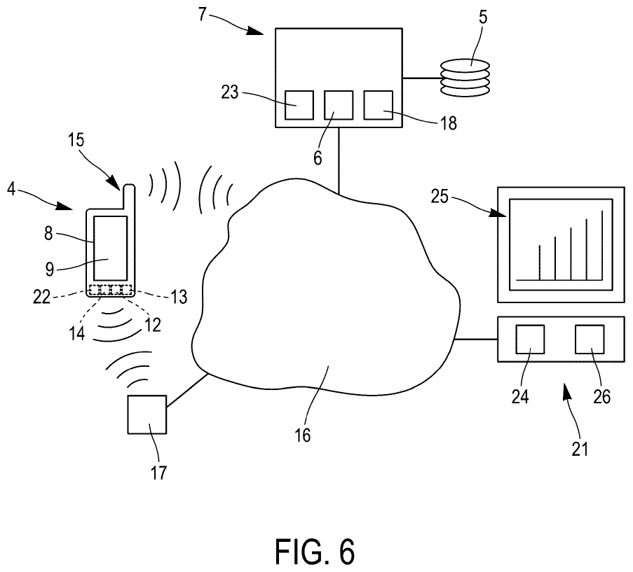

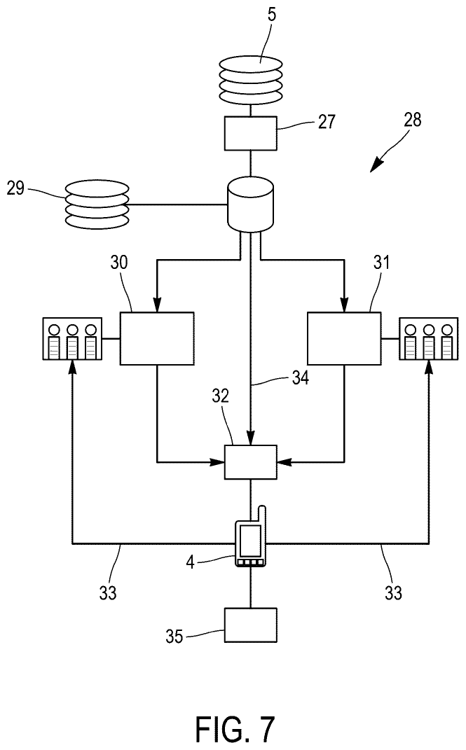

One embodiment of the temporal location system will be described below, with reference to FIG. 6.

The system comprises a central server 7 exchanging with several types of remote computer stations 4, 21 via a network 16 such as, for example, the Internet network.

The computer station 4 is an autonomous portable device. It can for example be a computerized mobile phone of a user, commonly designated by “smartphone”. In the context of the invention, such a “smartphone” comprises a processor 22. The processor 22 is suitable for running computer programs residents of the computer station 4, and in particular the computer program which will be described in more detail below.

The “smartphone” also includes a memory 14, in which a certain amount of information accessible by the processor 22 can be stored.

The “smartphone” still has a man-machine interface 8 allowing a user to interact with the “smartphone”. The man-machine interface 8 comprises for example a screen allowing information to be displayed to the user, and a keyboard, allowing the user to enter information intended for the “smartphone”. The information entered can be stored in the memory 4. If necessary, these two functions are grouped together in the form of a touch screen 9 superimposing the display and entry of information.

The “smartphone” still has a clock 12 giving the time. Clock data can be stored in memory 14.

The “smartphone” also has a geolocation module 13. Such a geolocation module 13 is for example a system based on satellite positioning technology generally referred to as “GPS”. Such a system is based on a chip which receives information from several satellites in geostationary orbit, and is capable of determining its position on the ground by triangulation from the information received from the satellites. The determined position or location is stored in memory 14.

The “smartphone” also has a communication module 15, allowing the “smartphone” to communicate with the outside, and in particular with the server 7, via a network 16. It may be a wireless communication module 15, or a wired communication module. The communication module 15 can, if necessary, communicate with the server 7 via the network 16 via a router 17.

The server 7 is a computer server which includes a processor 23 capable of executing one or more computer programs. The server 7 notably comprises a communication module 6 adapted to communicate with the “smartphone”. Communication with the “smartphone” is two-way, but the transfer of information is done rather in the direction going from the “smartphone” to the server 7.

The server 7 also accesses a database 5 in which maps of the agricultural exploitations concerned by the service are stored, which are defined in the manner described below. The database 5 stores the data, whether processed or not, coming from the various “smartphones”. The database 5 also stores association information from the various “smartphones” to one or more agricultural exploitations. The database 5 also includes models of agricultural activities which are specific to the agricultural exploitation.

The server 7 includes a processing module 18. The processing module 18 is adapted to process the data received from the “smartphone”, according to pre-established methods which will be described below. Thus, the data stored in the database 5 can comprise raw data as received from the “smartphones”, and processed data resulting from the processing of the raw data by the processing module 18. If necessary, the agricultural exploitations are distributed on several servers.

The system may also include a personal microcomputer 21. According to one embodiment, the personal microcomputer 21 is distinct from the “smartphone”. That said, in some cases, depending on the authorizations, a “smartphone” can be used to implement the functions provided by the microcomputer 21, and it can even be the same “smartphone” as the one used for the measurement of location data at a time.

The personal microcomputer 21 includes a processor 24. The processor 24 is suitable for executing resident computer programs on the personal microcomputer 21. For example, one of the computer programs in question is a network browser. The personal microcomputer 21 also includes a man-machine interface 25, such as a screen and a keyboard and/or a mouse. The personal microcomputer 21 includes a communication module 26 allowing it to communicate with the server 7 via the network 16.

The network browser of the personal microcomputer 21 provides access to an Internet page stored on the server 7, and providing the personal microcomputer 21 with structured information developed by the processing module 18 from the data received from the various “smartphones”.

The system just described can operate as follows.

### Installation Step

During an installation step, a user wishes to benefit from the computerized system. This user here is typically the operator of the agricultural exploitation.

First, the agricultural exploitation is mapped. It will be noted that the system can integrate several agricultural exploitations for the same user. In the following example, we describe the mapping of an agricultural exploitation, the configuration and the implementation for another agricultural exploitation of the same user being similar. In case of multiple operators, the server operates in parallel for each of the operators according to the features below.

If the user already has a map of the agricultural exploitation, it can be imported. This is the case, for example, in France, where agricultural exploitation mapping is already available on the TelePAC system.

The cartography of the agricultural exploitation comprises a plurality of adjacent and/or disjoint agricultural parcels 1. An agricultural parcel is generally polygonal, being bordered by rectilinear objects such as roads, hedges, etc. . . . , or partially polygonal, when it is partially bordered by a natural element such as a wood, a watercourse or a body of water. The agricultural parcel may in particular be a field dedicated to the cultivation of one or more plants, or a livestock parcel. The agricultural parcel may or may not include a building.

The agricultural parcel is defined by its coordinates, in particular by the coordinates of the points of its perimeter or of certain remarkable points of its perimeter (corners). The coordinates in question can be defined in a geolocated system, such as the so-called “GPS” system.

Each agricultural parcel is also characterized by an identifier configured by the user, such as, for example, an integer, or a string of characters, for example “Field 1; Field 2; Field 3; . . . Breeding 1; . . . .».

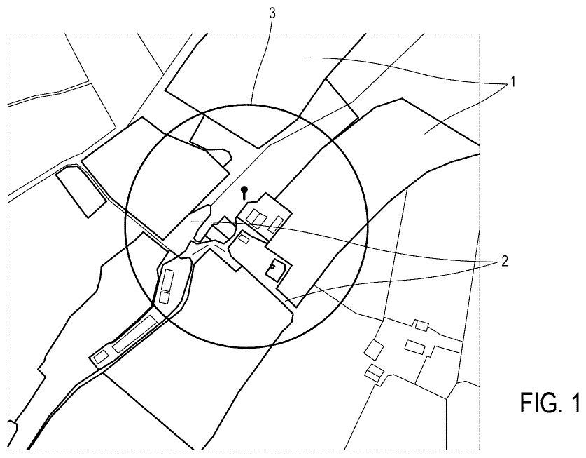

As can be seen in particular in FIG. 1, the zones defined by the agricultural parcels taken together do not cover the entire surface. Indeed, in this zone, there are also portions that do not correspond to agricultural parcels such as, in particular, roads or paths, unexploited natural objects such as bodies of water, watercourses, unexploited woods, and unexploited buildings.

The zones 2 complementary to the zones defined by the agricultural parcels taken together are characterized together by an identifier, such as, for example “non-parcel zones”. By “non-parcel zones”, we therefore refer to any point outside an agricultural parcel as defined above. Thus, the combination of zones 1 of agricultural parcels and non-parcel zones 2 paves the ground, within the meaning of the mathematical definition of “paving”.

The configuration also includes the definition of one or more particular zones 3 associated with the agricultural exploitation. These particular zones are for example defined by geometric primitives independently of the topology of the ground. According to a example, a particular zone is defined as a circle of configurable radius, centered on a particular point on the map. Other examples may include polygons of parameterizable size. The particular zone is also characterized by an identifier. For example, a particular zone 3 is defined around the agricultural exploitation office, and is characterized by the identifier “Headquarters”.

Thus, the particular zone 3 can, if necessary, cover one or more zones defined by an agricultural parcel 1, or a zone 2 identified as “non-parcel zone”.

The installation further includes setting up user handheld systems 4. In this example, one user is described, but the configuration can also be carried out for several users on the same agricultural exploitation, or on various agricultural exploitations gathered in the same service. The user can be the operator. Alternatively, or in addition, a user can be an agricultural worker who is not the operator.

In this example, the portable system 4 is a smart phone of a user. The “smartphone” is identified by an identifier which can, for example, be the call number of the “smartphone”. However, another identifier can be used, if necessary. The identifier is thus attached to the agricultural exploitation being configured.

One or more agricultural activities are also defined for the exploitation. An agricultural activity is defined as a set of agricultural tasks. The agricultural tasks of an agricultural activity are distributed according to a schedule. Each agricultural task can be characterized by one and/or other of the following characteristics: an identifier, a duration, an agricultural parcel identifier, a start time, an end time, a user identifier. According to an exemplary embodiment, an agricultural task “Pickup of female turkeys” is defined as being a task lasting eighteen hours, taking place in a “Breeding” place. According to an example, an agricultural task “Unloading turkeys” is defined as being a task lasting 1 hour taking place in a “Breeding” place.

An agricultural activity is defined from a plurality of agricultural tasks as defined above, distributed according to a calendar. For example, we can provide an agricultural activity, bearing the identifier “Turkey Breeding”, comprising an agricultural task “Unloading turkeys” on day D0 and an agricultural task “Pickup of female turkeys” on day D84 being 84 days after day D0.

The agricultural tasks of an agricultural activity can also be linked by their place. Thus, in the example above, the “Breeding” of the agricultural step “Pickup female turkeys” is the same agricultural parcel identifier as the “Breeding” of the agricultural step “Unloading turkeys”. If the agricultural exploitation includes several agricultural parcels of the “Breeding” type, the agricultural activity “Breeding Turkeys” can be assigned to the agricultural parcel “Breeding 1”, in which case the corresponding agricultural tasks are assigned to the agricultural parcel “Breeding 1”.

It should be noted that, where appropriate, some agricultural activities may include tasks taking place in several different parcels. This will be the case, for example, of the breeding of a herd that moves from breeding parcel to breeding parcel over time.

An agricultural activity can thus comprise at least two agricultural tasks, as defined above, and typically at least five, or even at least ten agricultural tasks, as defined above.

An agricultural activity can thus be represented, from a mathematical point of view, as a time series, i.e. for example a matrix comprising a certain number of vectors (“task identifier”; “parcel”), each vector corresponding to a time slice.

For the agricultural exploitation, agricultural activities are defined, for example from predefined models of agricultural activities. For example, an agricultural activity can be made specific to an agricultural exploitation by adjusting an agricultural step, or by adjusting a relationship between agricultural steps of the same agricultural activity, for example an adjusted calendar compared to that of the model.

During configuration, it is possible to enter additional information relating to agricultural activities and specific to the agricultural exploitation. For example, if an agricultural task is most often implemented in the morning, this information can be filled in. If an agricultural task is most often implemented by a particular user, this information can be filled in.

Furthermore, in the configuration phase, if the system is supposed to come into operation on a certain commissioning date, if possible, information relating to agricultural activities already started on the commissioning date is entered in the calendar. For example, if the system is supposed to be put into service on February 1, all the agricultural activities that will be in progress on February 1 are listed, and the agricultural tasks completed or started before February 1 are entered in the calendar.

The database 5 is configured to be able to receive and store information relating to the “smartphone”, received by the communication module 6 from the central server 7.

To be able to use the service, the “smartphone” contains a computer program relating to the service. If this computer program is not installed on the “smartphone”, an installation is planned, for example by means of a download.

### Use Step

The system which has just been described is used in the following way by the user.

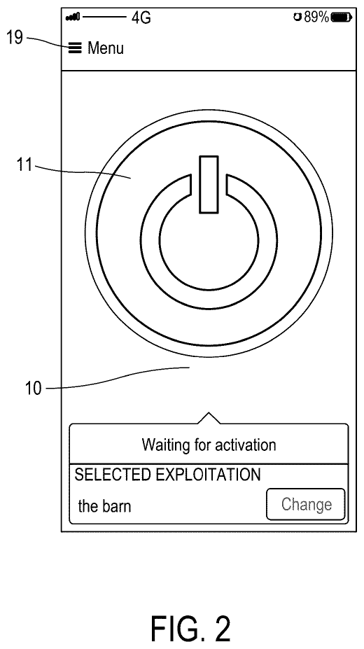

At the beginning of his working day, the user accesses the computer program. This access is for example performed via the man-machine interface 8 of the “smartphone”, where the user selects an icon corresponding to the computer program and present on his touch screen 9. The user then accesses a control screen 10, as shown in FIG. 2.

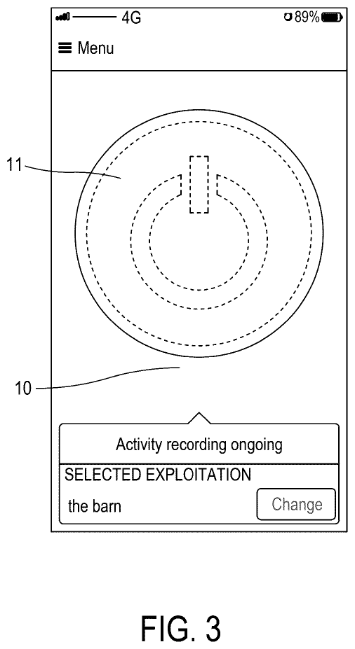

On access to the control screen 10, the commissioning button 11 of the computer program is automatically switched to “on”, or the user controls this switch to “on” by an action, and the screen is then as shown in FIG. 3 according to an example embodiment. The fact that the geolocation is in “on” mode is displayed on the screen of the “smartphone” by any appropriate means. The time supplied by the clock 12 at this instant is recorded in the memory of the “smartphone”.

The service requires the geolocation module 13 of the “smartphone” to be active. If necessary, the computer program checks that the geolocation module 13 of the “smartphone” is active and, failing that, informs the user or guides him to activate his geolocation module 13.

The user can now use his “smartphone” for any other need, or put it away. The computer program remains active in the background.

Regularly, the geolocation module 13 geolocates the “smartphone”. The location information of the “smartphone”, as well as the instant associated with this geolocation, determined by the clock 12 of the “smartphone”, are stored in the memory 14 of the “smartphone”. This step is for example implemented every second, every 10 seconds, every minute, or every 2 minutes.

For example, the user, who is also the operator, switched the geolocation to the “on” mode after having breakfast, which he took at his home, which is also the headquarters of the exploitation. He puts his “smartphone” in his pocket. He starts his day at the office for administrative procedures.

Then, he takes his car, and goes to the shed where he gets into the tractor, and spends his late morning plowing field #7 near the shed.

Then, he returns to headquarters, still in a tractor, to receive a delivery. He takes the opportunity to make a few phone calls from the office, and to have lunch.

In the afternoon, he goes on foot to make a control visit to poultry farm #2 located in an agricultural parcel near the headquarters. Finally, he goes by tractor to field #3 to start plowing it. At the end of the day, he brings the tractor back to the shed, and returns to headquarters by car.

At the end of his working day, the user accesses the computer program. This access is for example performed via the man-machine interface 8 of the “smartphone”, where the user selects the icon corresponding to the computer program and present on his touch screen. The control screen 10 of FIG. 3 is then displayed.

On access, the user can command the switching of the commissioning button 11 of the computer program to “stop” by an action. The time provided by the clock 12 at this instant can be recorded on the memory 14 of the “smartphone”.

If necessary, the computer program can offer to cut off the geolocation module 13 of the “smartphone” and inform the user of this, or guide the user to deactivate his geolocation module 13.

If necessary, the user may have to cut or start the computer program in the middle of the day.

For the user, the operation is therefore extremely simple, because it amounts to pressing the commissioning button 11 and, if necessary, the geolocation.

If necessary, the start and end of operation can be automatic, based on start and end times pre-programmed via an interface.

Regularly, the data stored in the memory 14 of the “smartphone” are transmitted by the communication module 15 thereof to the server 7.

This communication is less frequent than the determination of the geolocation, for example at least ten times less frequent. It is for example carried out once per hour, twice per day, or once per day. For example, it can be provided that it is carried out after the geolocation has been stopped at the end of the day by the user.

The communication can for example take place when the “smartphone” finds that it is in a coverage area of a network 16 allowing this communication. As an alternative or in addition, the communication can for example take place when the “smartphone” is placed in wired or wireless communication with a local router 17 having means of communication to the server 7.

The data communicated includes the identifier of the “smartphone” as well as the associated location data and clock data. The data received by the communication module 6 from the server 7 is stored in the database 5. According to one embodiment, the “smartphone” does not carry out any pre-processing, so as to save battery power.

### Processing Step

The processing module 18 of the server 7 will process the data associated with the identifier.

For example, data is filtered prior to processing. It is possible to implement a computerized pre-processing module 27 which applies an extended Kalman filter.

The identifier is associated with one or more agricultural exploitations. The location of the user can therefore be determined by comparing the measured location with the locations of the zones of the exploitation.

Through this comparison, the processing module 18 is able to identify a zone within which the location of the user is located.

A duration will be assigned to a zone from the moment a sufficient number of consecutive location data are inside the same zone. The sufficient number can be determined either by a predefined number of measuring points or by a minimum duration. As an example, it is defined that 5 successive measurement points in the same zone are necessary before the processing module 18 considers that the measurement points belong to the same zone. Alternatively, 10 successive measurement points in the same zone are required to confirm the zone.

The duration spent in the zone is then calculated as the difference between the last instant spent in the zone and the first instant spent in the zone, and this duration is recorded associated with the identifier of the zone.

All measurement points are processed according to these provisions. This results in an allocation of a user's presence time in different zones. If applicable, a start time and/or an end time are also recorded for each duration in a zone.

Location data can also be processed to determine a type of user movement within the parcel. For example, according to the instantaneous speed of movement, and by comparison with pre-established models, one can assign the type of travel to an entry from a possible list of travel modes, which can include the entries “pedestrian”, “tractor”, “car”, . . . .

The zone in question can be an agricultural parcel 1, or can be a zone 2 called “non-parcel zone”, in particular if the user spends time outside the agricultural exploitation (visiting a supplier outside the agricultural exploitation, or time spent on the road, for example).

In the case where the zone in question is said to be “non-parcel zone”, a differentiated treatment may be implemented, depending on whether the location in question is located in the specific zone 3 (for example the specific “Headquarters” zone) or not. Thus, if the measure is inside “non-parcel zones” 2 and special zone 3 “Headquarters”, it is assigned to special zone 3 “Headquarters”. Otherwise, it is assigned to “non-parcel zones” 2.

The processing module also determines time durations in transport zones by taking into account a succession of locations detected in different predefined zones.

In particular, if the processing module has determined a first duration of time in a first zone of agricultural parcel 1 or particular zone 3 “Headquarters”, and a second duration of time in a second zone of agricultural parcel 1 or particular zone 3 “Headquarters”, spaced between them by a certain duration of time in a non-parcel zone 2, said certain duration of time in “non-parcel zones” is determined as a travel time.

In particular, travel times are counted only if they correspond to transport related to the professional activity. Travel times that are not related to the professional activity are not counted. In particular, the transport times between a first agricultural parcel zone and a second agricultural parcel zone are counted. Also counted are transport times towards an agricultural parcel zone from a non-parcel zone or from the head office, or from a non-parcel zone or from the head office to an agricultural parcel zone. In particular, trips between a non-parcel zone or the head office and a non-parcel zone and the head office are not counted.

The processing module also determines pause time durations, corresponding to time durations where the “smartphone” is stationary, “stationary” being defined by reference to a predefined minimum of movement. This period of time of immobility is then not counted in the time spent in a zone corresponding to an agricultural parcel 1.

Thus, in the example presented above, upon receipt of the location data at a time for the user, for example carried out all at once at the end of the day, the processing module 18 determines a time spent at the headquarters, a time spent at Field #7, a time spent at field #3, a time spent at the poultry farm #2, a transport time, and a time spent in non-parcel zones, as well as the start and end times of each interval.

In particular, if the road taken by the user to get to the shed is located on the edge of an agricultural parcel 1, or even between two agricultural parcels 1, the location data at a time recorded during this period will not be permanently associated with an agricultural parcel and, consequently, these data will be attributed to a travel time.

There are several ways to interpret the data collected and previously processed as described above.

For example, the interpretation step is implemented every day. It can be implemented each time the reception of location data indicates that a user has changed agricultural parcels. This will be the case in particular if each task of an agricultural activity is associated with a single parcel.

In the continuous regime, the interpretation step is implemented at a time when there is already a pre-populated calendar of agricultural tasks performed by users, as determined by previous implementations of the interpretation step.

### First Embodiment

According to a first embodiment, the interpretation step comprises a classification of the received temporal location data, and an association of these data with an agricultural task. The association with an agricultural task is done for example by identifying a likely agricultural task corresponding to the temporal location data, and in particular a most likely agricultural task. This association is made by a computerized interpretation module 28 which digitally processes the temporal location data, the pre-filled calendars, and the agricultural activities defined for the agricultural exploitation.

Thus, in the presented example, location data of the type: User #2 stayed between 8:17 a.m. and 12:14 p.m. in the agricultural parcel “Turkey Breeding 3” can be processed to: Mr. Pierre Morin carried out between 8:17 a.m. and 12:14 p.m., i.e. for 3 h57, the “Pickup Female Turkeys” step in the agricultural parcel “Turkey Breeding 3”. This classification is made possible by the fact that, in the database, the identifier of the “smartphone” of user #2 is associated with “Mr. Pierre Morin”, and in that the operating schedule shows that, the day before, time was allocated to the agricultural task “Pickup Female Turkeys” in the agricultural parcel “Turkey Breeding 3” without the total time recently spent in this agricultural parcel yet reaching the 18 hours provided in the database for this agricultural activity for this agricultural exploitation.

The search for a likely agricultural task which would correspond to the temporal location data may use interpreted or uninterpreted data associated with agricultural tasks, agricultural parcels, users, agricultural activities and/or calendars.

Thus, the computerized interpretation module 28 determines a most likely agricultural task for the temporal location data. For example, the computerized interpretation module determines, for a plurality of candidate agricultural tasks selected from the available agricultural tasks, a distance between the agricultural activity model comprising this available agricultural task and agricultural activities constituted from past agricultural tasks and information obtained via the temporal location data. The distance in question can be any suitable distance.

Sometimes the temporal location data may only have a loose correlation with the modeled agricultural activities. This may be the case in particular if the user starts an agricultural task earlier than expected in the agricultural activity models (for example to anticipate the fact that he will not be able to perform the agricultural task at the desired time, or because the climate pushes him to implement this agricultural task in advance), or later than expected in the agricultural activity models (for example due to a current activity load).

In addition, the computerized interpretation module can also take into account other agricultural activities of the calendar to interpret the current agricultural task. For example, the computerized interpretation module takes into account the fact that an agricultural activity “breeding turkeys” has recently ended in the parcel “Breeding Turkeys 3” to determine that a new agricultural task in the parcel “Breeding Turkeys 3” corresponds to the first agricultural task of a new agricultural activity “Breeding Turkeys” in this parcel.

Provision can be made for the interpretation module to also take account of external data. “External data” refers to data from data sources 29 external to the agricultural exploitation. A category of outdoor data particularly relevant to certain embodiments of the invention includes weather data relating to the location of the exploitation. Meteorological data may include the existence, or even the intensity of rain during a given period. Indeed, the rain can have an impact on the practicality or case of carrying out certain agricultural tasks. Thus, in this case, the meteorological data can be entered into the models of agricultural tasks: it is indicated that certain agricultural tasks can be implemented in dry weather only, or preferably in dry weather.

In use, the computerized interpretation module 28 receives meteorological data relating to the agricultural parcel from the external data source. The interpretation module additionally takes into account the meteorological data to determine the implemented agricultural task.

According to another example, the meteorological data can comprise ambient temperature data. Indeed, depending on the meteorology, the biological processes of plants can be altered in such a way as to affect the calendars of agricultural activities. Thus, the interpretation module can be adapted to analyze meteorological data and deduce an index of allocation of agricultural activity schedules. Meteorological data is taken into account in the form of a modulation of the calendar of agricultural task models. The computerized interpretation module 28 may comprise a classifier 30 relating to the models of agricultural activities defined for the agricultural exploitation.

As a variant, the computerized interpretation module 28 can comprise a classifier 31 relating to the models of agricultural activities defined for all the agricultural exploitations.

If necessary, the computerized interpretation module 28 implements these two classifiers 30, 31, and a selector module 32 applies a computerized selection step making it possible to determine an agricultural task from the results of the two classifiers. This selection is for example carried out by using a level of confidence in the result provided by each classifier. Indeed, as each classifier determines an agricultural task likely to be associated with the collected data, a probability of association can be determined simultaneously. This probability of association is used for selection. The selection history 34 for the user or the exploitation can also be used for the selection.

The system which has just been described can also comprise a computerized learning module 33. The computerized learning module 33 is used, from time to time, to determine agricultural activity patterns from the agricultural activity information collected by the server relating to the agricultural exploitation. The computerized learning module 33 is suitable for determining agricultural activity models from the agricultural activity information collected by modifying pre-existing agricultural activity models from the collected agricultural activity information.

According to the achievements, it can be expected that the computerized learning module 33 is specific to the agricultural exploitation. In doing so, the specificities of the agricultural exploitation are taken into account. As a variant, the computerized learning module can be common to several agricultural exploitations, so as to collect information on agricultural activities from several agricultural exploitations, and to take into account all of this information for the modification of the models. In doing so, a model of agricultural activity that is statistically more common to all agricultural exploitations is determined.

### Second Embodiment

In a second embodiment, the classification is performed by a convolutional neural network.

According to this other aspect, the invention proposes to shift the technical problem of classifying the time series of data collected to a technical problem of classifying an image representative of this series for which the interpretation module 28 uses a convolutional neural network.

Indeed, convolutional neural networks achieve excellent results in image classification. The objective is to transform the collected data into an image representative of these data and then train a neural network to classify the images constructed according to the most likely agricultural task to be associated with an image on the basis of the agricultural activity model.

Thus, each time an interpretation step is implemented (every day or when changing parcels, etc.), the first step consists in creating the associated image from the data collected.

Construction of images to train the AI module based on a verified task schedule.

In general, the constructed image represents the collected location data to which are added other information specific to the time period covered by the collected location data.

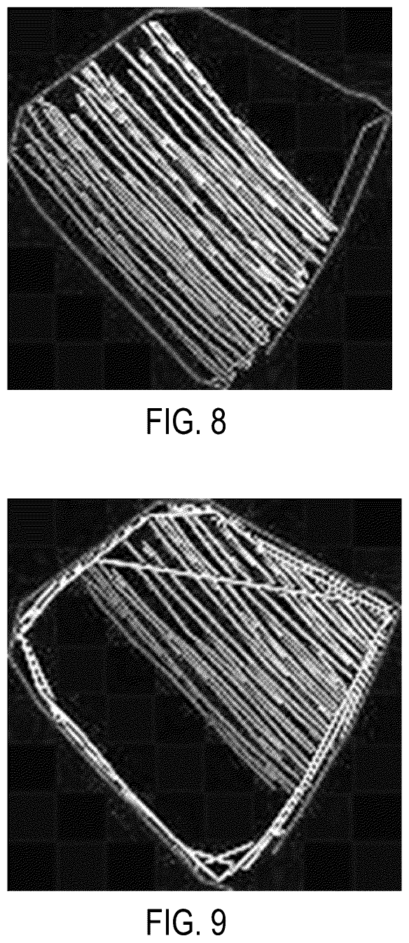

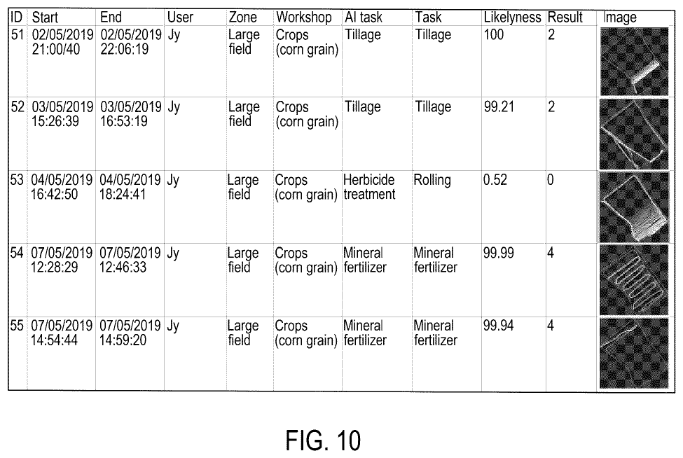

Each image is built by superimposing several layers. These overlapping layers build the image. FIGS. 8 and 9 illustrate examples of constructed images.

From the location data to be interpreted, it is possible to represent the GPS track on the image, i.e. the operator's trajectory. Ideally, it is possible to vary the intensity of the location point according to the corresponding timestamp. In this way, the direction of the trajectory is represented on the image and the speed of movement as well.

Concretely, the GPS track can be drawn in levels of white on all the other layers of the image or be the subject of a specific layer with a specific light intensity and tint.

The other layers make it possible to represent other information specific to the time period over which the time-stamped location data collected is spread. This information can come from or be deduced from location data and databases of agricultural exploitations and agricultural activities or represent external data.

Each layer of the image has an intensity and a hue. This intensity is determined from the information to be encoded on the layer.

It is also possible that each layer is formed by a tessellation according to two different intensities of a given hue, for example forming a checkerboard. The interest is to obtain a greater number of information on each layer. Indeed, a single intensity can simply vary from 0 to 255 which offers 256 possibilities while a checkerboard based on two intensities allows 256×256 possibilities. In this way, it is, for example, possible to assign to each type of parcel a pair of intensity

We will now present examples of information that can be represented, or encoded, on the layers of the image:

For example, it is possible to encode the known previous task executed in a parcel determined by the location data. In this case, each agricultural task (for example, “Unloading turkeys” or “Pickup female turkeys”) corresponds to an intensity of one shade, or a pair of intensity of one shade to, for example, paving the layer. The representation in the image of the previous task is then carried out with the corresponding intensity.

For example, it is possible to encode on a layer one or more parcel place identifiers (Farm 1 for example) determined from the received location data. Here too, each parcel identifier is associated with an intensity or an intensity pair.

For example, it is possible to encode on a layer the type of zone to which the received location data correspond. Similarly again, we can represent the type of zone (zone 1, zone 2, zone 3) according to an intensity or a pair of intensity in the case of a paving of the layer.

For example, it is also possible to encode the type of movement of the user.

Any type of data, or information, specific to an agricultural activity, and therefore allowing better classification, can be encoded on an image layer:
temporal zoning data,
the agricultural parcel determined according to the temporal zoning data and the agricultural exploitation database,
the contour of the agricultural parcel,
the previous task carried out in the determined agricultural parcel,
the time elapsed since the last task performed,
the type of agricultural parcel,
the user using the portable system, or
the machine using the portable system.

For example, it is therefore possible to integrate the outline of an agricultural parcel determined from the location data into the image. This outline can be integrated into any layer provided that it is distinguishable from the information already encoded on it. For example, it can be integrated into a layer according to an intensity other than the already used one(s). It is also possible to provide for the contours to be in black. Such contours are visible in the constructed images shown in FIGS. 8 and 9.

Similarly, temporal zoning data is visible in the constructed images shown in FIGS. 8 and 9.

It is also possible to integrate into the image white patterns, or in another hue with a given intensity, from geometric primitives, for example circles or squares, in a layer of the image. These geometric patterns can be parameterized according to information to be represented correlated with the information determining the intensity or the intensity couple of the layer or according to the same information determining the intensity of the layer. For example, a white circle pattern whose diameter indicates the time elapsed since the last task carried out in the determined agricultural parcel can be integrated into the layer encoding the information “previous task carried out in the determined agricultural parcel”.

As said above, any type of data specific to an agricultural activity, and therefore allowing better classification, can be encoded on an image layer. The principle of construction of the layer dedicated to this data remains the same:
each value of the data or information to be encoded is associated with an intensity (or a pair of intensity),
if necessary, a pattern generated from a geometric primitive is associated with these data and parameterized according to the values taken by them.

The encoding layer is then generated according to the determined associations and, if necessary, the determined parameterization.

Moreover, in the case of a tiling of the plane of the layer, it is possible to parameterize the tiling (the size and the shape of the elementary mesh in the case of regular tiling for example, or the definition, or thickness of the line, of the tiling) according to the values taken by the data to be represented.

The activity-specific data gathered on the same layer can be different but linked, or correlated, between them: for example, the paving of a layer can be determined according to the last task carried out in the agricultural parcel and the pattern generated from a geometric primitive can be parameterized according to the time elapsed since this last task. Thus, the two pieces of information encoded on the layer are different (last task and time elapsed since than) but linked together.

The previous examples given relate to information from location data collected directly (GPS track) or after comparison with agricultural activity or exploitation databases.

### External Data

In the second embodiment, it is also possible to take account of external data.

“External data” refers to data from data sources 29 external to the agricultural exploitation. The objective being to encode the maximum of information resulting from the data collected on the image so that this one is the most representative of these, certain layers of the image can be built from these external data.

A category of outdoor data particularly relevant to certain embodiments of the invention includes weather data relating to the location of the exploitation. Meteorological data may include the existence or even the intensity of rain during a given period.

Thus, in this embodiment too, it is also possible to encode on an additional layer this meteorological data.

By taking up the examples of layers given above, it is then possible to provide a layer encoding the meteorological information.

Provision can be made to encode meteorological information for the day such as solar luminosity, wind speed, precipitation. It is possible to encode this same information for the next day and the day after. In this case, weather forecasts are used in addition to weather data from external databases. This layer is then divided, for example into three vertical or horizontal bands each representing one day among the three.

Data from other agricultural exploitations may be relevant to determine the agricultural task performed during a given time period by the user. For example, during the harvest season, it is very likely that operators in the same geographical area harvest at very similar times. Similarly, sowing periods for farmers, or foaling for horse breeders generally have specific periods and durations in the year. Thus, allowing the classifier to take such information into account is useful.

Thus, it is possible to dedicate a layer of the image to information specific to other agricultural exploitations and in particular the agricultural tasks carried out by other farmers in the same field of activity as the user.

Thus, the external data that can be encoded on a layer, potentially a layer on which data specific to the agricultural exploitation is encoded, can in particular be:
weather forecasts, one day ahead or three days ahead for example,
activities carried out on other agricultural exploitations at the same time, at the same time of year or under similar weather conditions, or
the production specification(s).

### Training

Then we train the classifier for the first time by associating a task with each image constructed as explained above. This association is achieved when the farmer manually indicates the tasks performed in each parcel during the day. The interpretation module then has an image constructed for each parcel and the manually entered task.

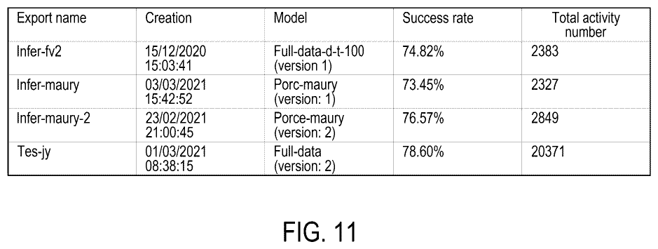

FIG. 10 illustrates an example of the results of the training of the classifier. The task column “Task” indicates the known task whose temporal zoning data is submitted to the classifier so that it associates them with an agricultural task.

The “AI Task” column indicates the result of classification by the classifier. To classify location data, the classifier creates an image shown in the “Image” column.

In this embodiment, the constructed images include an outline of the agricultural parcel, for example “Large field”, and a GPS trace resulting from the collected location data.

In the third row of FIG. 10, the task associated with the location data is “Herbicidal treatment” (“IA task” column) while the known task is “Rolling” according to the “Task” column. This association by the classifier is an example of erroneous results that allow training the classifier.

Alternatively, if each image corresponds to a day, the classifier has for each image a sequence of tasks performed during the day.

The training of the classifier can be updated as soon as new tasks are assigned to images (for example with each classification, or with each manually confirmed classification) and/or the classifier can be trained at specific times on the basis of new data (specific to the agricultural exploitation or not) from which it is possible to build new images associated with known agricultural tasks.

It is still possible that the user, ie the farmer generally, manually enters his activities, and the associated tasks, carried out during the day, or any appropriate period of time, in order to create images specific to the agricultural exploitation for which the associated activities and tasks are known.

The known tasks used to train the classifier can come from other exploitations. In this way, it is possible to use verified results from other agricultural exploitations, ie images associated with known tasks performed in other agricultural exploitations. This can be useful for the first training of the classifier of a given exploitation. But it can also make it possible to take into consideration the particularities common to similar agricultural exploitations (geographically or by sector of activity, for example).

It is possible to test the classifier by submitting to it images for which the task to be assigned is known as explained above. We then see if the results are satisfactory. Similarly, the test images may come from other exploitations.

Time of implementation and sequencing of the batch of data to be interpreted

If the interpretation step is implemented according to a predetermined duration of data collection, or even a minimum amount of data collected or simply at any time, it is possible to represent all the data on a single image and train the classifier to recognize the successive tasks performed during the data collection period.

In this case, according to the previously explained construction of the layers as an example, the image can contain several parcels on the layer representing the parcels and for each parcel represented, the layers of previous zones and tasks represent the information of previous zones and tasks for each parcel by varying the intensities or pairs of intensities of zone or task from one parcel to another.

However, it is preferred that the interpretation step be carried out for a batch of location data corresponding to a given parcel or that each change of parcel detected according to the location data leads to the creation of a new image. The constructed images of FIGS. 8 and 9 illustrate this embodiment.

For example, by setting a minimum number of location points located outside the last determined agricultural parcel (for example if the x and y coordinates no longer satisfy the equations of the last determined agricultural parcel according to the agricultural exploitations database), it can be determined that the data of higher chronological order no longer correspond to the last determined parcel so that these data should not be taken into account for the construction of the image associated with the last determined parcel.

Similarly, by setting a minimum number of location points located inside an agricultural parcel, an agricultural parcel is determined and it is considered that the data of higher chronological order belong to it and must therefore be taken into account for the construction of the image.

In other words, the batch of collected data to be interpreted is sequenced agricultural parcel by agricultural parcel. In this way, a sequencing by parcels of the batch of collected data to be interpreted is carried out. Then an image is constructed for each batch of data corresponding to an agricultural parcel.

The distinction of zones 1, 2 and 3 can help with this sequencing since the particular zones 3 correspond to locations outside agricultural parcels.

Thus, an image corresponds to an agricultural parcel of the agricultural exploitation and the classifier aims to attribute to the image the most likely agricultural task carried out in the parcel.

In this case, since each image corresponds to a determined parcel, the previous examples are simplified: on each image, a layer corresponds to the previous task carried out in the parcel, a layer corresponds to the type of zone to which the parcel belongs, a layer corresponds to the identifier of the parcel. The pattern, for example, a circle, represents the time elapsed since the last task performed (configured according to the diameter of the circle) and finally, we integrate the GPS trace of the trajectory (included in the parcel therefore) and the contour of the parcel.

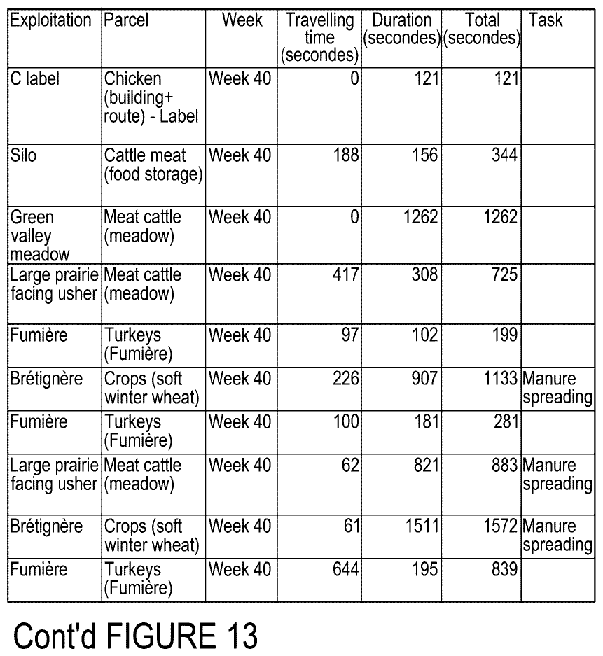

FIG. 13 illustrates the data manipulated by the classifier. Based on the collected location data, the computerized interpretation module determines the agricultural exploitation, the parcel, the time spent in the parcel.

From these data, the classifier builds an image as illustrated in FIGS. 8 and 9

In addition, the user is determined by the identifier of the autonomous portable device.

### Interpretation

We place ourselves in the case where each image corresponds to a parcel determined according to the location data and the previously explained sequencing of the batch of data to be interpreted.

Once trained, the neural network classifier is able to classify each image: for each input image of the classifier, it assigns this image the most likely agricultural task.

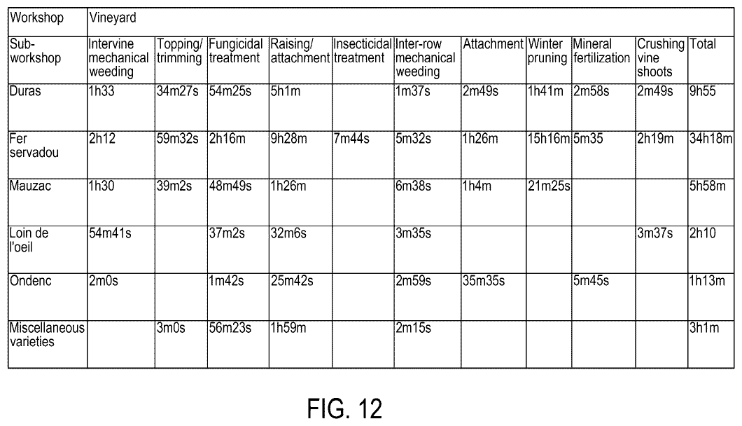

For example, in the embodiment illustrated in FIG. 11, each row corresponds to a version of the classifier (“model” column). The “Success percentage” column indicates the performance of the classifier based on the classification results of the model collected in a results database (“Export name” column).

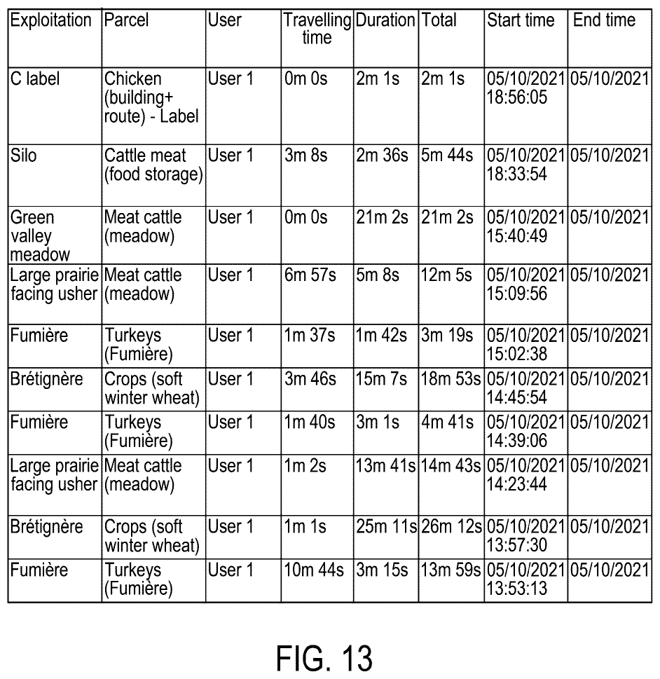

An example of the results of classifying temporal zoning data into an agricultural task is shown in FIG. 12. The lines in the “Sub-workshops” column indicate the parcels corresponding to each grape variety of a winery: “Duras”, “Fer servadou”, “Mauzac” or “Loin de l′œil”.

Then in the column, the identified tasks are listed: “Mechanical inter-row weeding”, “Topping/trimming”, “Fungicide treatment”, “Track maintenance”, “Lifting/joining”, “Insecticide treatment”, “Inter-row mechanical weeding”, “Tie-up”, “Winter pruning”, “Mineral fertilization” and “Crushing vine shoots”.

The classifier makes it possible to recognize the task carried out in each parcel and for how long over a predetermined period of time. In this example, the time period is the year 2021. Nevertheless, it could be a day or a week so that it is possible to know one's schedule thanks to the classifier.

Shorter durations are shown in FIG. 13 in the “Duration” column. Here, the performed task determined by the classifier is “Manure spreading”.

Thus, unlike the tasks entered manually by the operator, the identified tasks are entered by the classifier.

### Editing Step

Whatever the embodiment used, the classifier determines a most likely performed task that it proposes to the user.

If necessary, the user can access an editing interface, allowing him to control or even edit the data entered. This can be useful especially if the user needs to report an unexpected activity, such as a phone call, a breakdown, or other. The editing interface can be available from menu 19 of the computer program interface of the “smartphone” (see FIG. 3), via a web interface accessible from a microcomputer, and allow the data to be modified at the level of the “smartphone” before sending to the server, or at the level of the server 7.

Thus, the server sends to the “smartphone” information relating to the agricultural task determined by the interpretation module, and the “smartphone” presents, on a graphic interface, the determined agricultural task, and offers the user the possibility of confirming or not the determined agricultural task. The information entered by the user is sent back to the server, which can take it into account for the definitive recording of an agricultural task 35 in the user's calendar. In the event of non-confirmation by the user of the agricultural task determined by the interpretation module, the user may be asked to manually enter the agricultural activity actually performed in a list. This manual validation step is preferably carried out regularly, for example daily, so that the agricultural tasks actually carried out are taken into account the next day by the interpretation module.

As can be seen, however, in FIG. 3, the areal extent of menu 19 is small relative to the areal extent of power button 11. As a result, the commissioning button 11 is the main interface of this screen.

### Consideration of Classification Results

According to the performance of the classifier, whatever the embodiment used, it is possible to consider that the tasks classified by the processing module but not confirmed manually can be reused in the training phase of the classifier.

If necessary, it is possible to weigh the importance of the images of known agricultural tasks used to train the classifier: the tasks classified but not confirmed can for example be of less weight than the tasks classified and confirmed manually and the tasks entered manually.

### Analysis Step

The operator can access the processed data from a supervision interface 20. It will be noted that the operator can be the user but that, in certain cases, all the users do not have access to the supervision interface 20. Access to the supervision interface 20 can be managed by authentication systems. The operator can thus access the information recorded for one or more users associated with its exploitation, including himself, if necessary.

Access is for example performed from a personal microcomputer 21 or other electronic device connected to the server 7 via a page accessible via the Internet network 16.

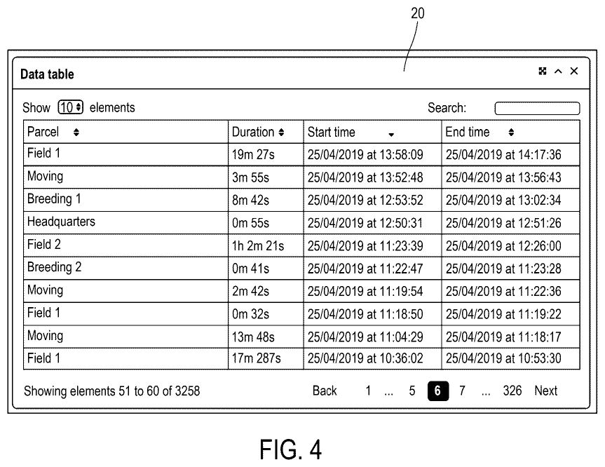

As can be seen in FIG. 4, the operator can for example access, for a given user, all the lines processed for the user.

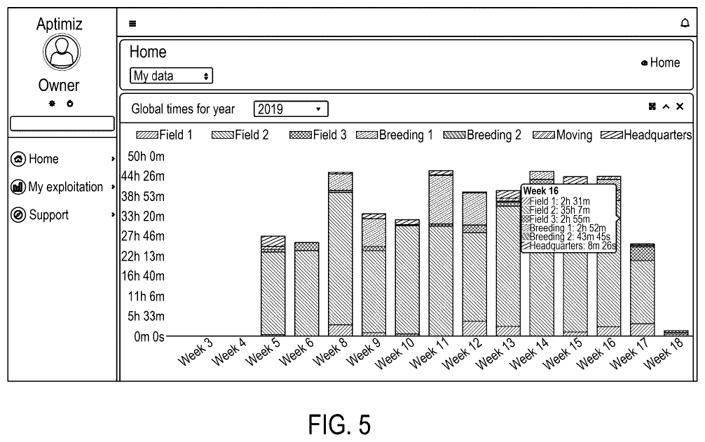

However, the information can also be presented in a non-chronological manner, for example accumulated over a configurable period, over one or more users and/or one or more zones. The operator can thus determine in particular the overall time spent in a particular zone, the overall time spent outside the zone, the overall time spent at headquarters, the overall time spent on break and/or the overall time spent traveling, over a configurable period, and/or the evolution of these quantities over time, as shown for example in FIG. 5.

### Variants

As a variant, it will be noted that the method, whatever the embodiment, is not necessarily implemented by a “smartphone” of the user. It could be a dedicated electronics package presenting the necessary functionalities. For example, the package may comprise a simplified man-machine interface comprising a mechanical on/off button.

Some of the methods described above can be implemented, whatever the embodiment, by computer programs executed on one or more processors. Several objects equipped with processors can work in a network, the steps of the method can be implemented by one or the other, or a plurality of processors communicating with each other.

The method, whatever the embodiment, which has just been described can be implemented for each agricultural worker equipped with a portable system 4.

Alternatively, whatever the embodiment, a given agricultural task may require the simultaneous presence of several users. In this case, the computerized interpretation module 28 determines the agricultural task from the temporal location data received from several portable systems.

Where appropriate, some agricultural tasks can be modeled in man.hour units rather than in hourly units. Thus, if an agricultural task is modeled for example in 18 man.hours, the interpretation module is able to recognize it, whether it is implemented by a user for approximately 18 hours (spread over several working days), or according to more complex organizations (two users for approximately 9 hours, or even one user for 9 hours then two users for 4.5 hours, or other scenarios).

Alternatively, regardless of the embodiment, the interpretation module 28 determines the agricultural task by taking into account the user's estimated type of travel, if the agricultural activity models are parameterized with the type of travel.

As a further variant, whatever the embodiment, certain agricultural tasks require the use of agricultural machinery. According to one embodiment, an agricultural machine of an agricultural exploitation is equipped with a device having similarities with the portable system of the users. This device stores an identifier of the agricultural machine, comprises a geolocation module making it possible to determine the location of the machine, and means of communication allowing it, at regular intervals, to send information concerning its temporal location to the server.

Agricultural tasks can be modeled to take into account the use of a type of agricultural machinery. For example, the agricultural task “Labour” is modeled to take into account the use of a tractor.

When configuring the system, the farmer can enter the identifiers of the different agricultural machines on the agricultural exploitation equipped with temporal location devices, as well as the type of these agricultural machines. For example, if the operator has several different tractors, each assigned to a remote identifier, each can be entered in the “tractor” category.

In this case, the computerized interpretation module 28 determines the agricultural task from temporal location data received jointly from a portable system 4 worn by a user and temporal location data from an agricultural machine. Thus, the simultaneous presence of an agricultural user and an agricultural machine on a parcel are taken into account by the computerized interpretation module 28 to recognize the agricultural task.

### Specificity of Treatment

The processing of the location data collected in order to associate this data with an agricultural task is different from known data processing in that it does not carry out a comparison between an ideal parameter and a data collected or calculated from the data collected.

Some data processing compares a time spent in a parcel on a date determined according to the location data collected with a pre-filled timetable to then deduce from this comparison the agricultural task carried out according to the location data collected.

Other data processing compares data other than location data with pre-populated template data.

A specificity of the data processing according to the invention is therefore not to compare the location data, or data calculated from them, with model data.

The processing of the location data according to the invention uses only the temporal links between the agricultural tasks of one or more agricultural activities according to the defined models of agricultural activities to deduce from the location data the performed agricultural task.

### REFERENCES

1 Agricultural parcel
2 Complementary zone
3 particular zone
4 portable system
5 database
Communications module 6
Central server 7
Human Machine Interface 8
Touch screen 9
Control screen 10
Commissioning button 11
Clock 12
Geolocation module 13
Memory 14
Communications module 15
Network 16
Router 17
Processing module 18
menu 19
Supervisory interface 20
Personal microcomputer 21
Processor 22
Processor 23
processor 24
Man-machine interface 25
Communication module 26
computerized pre-processing module 27
computerized interpretation module 28
data sources 29
external classifiers 30, 31
selector module 32
computerized learning module 33
history 34
agricultural task 35

1. A computerized method of interpreting location data of at least one agricultural worker, wherein the computerized method comprises:
a database of agricultural activities is provided comprising, for each agricultural activity, a schedule of at least two agricultural tasks, each agricultural task being characterized by a place identifier and a position in the schedule,
an agricultural exploitation database is provided, the database comprising at least one agricultural parcel characterized by a place identifier and a location,
providing temporal zoning data of the at least one agricultural worker received from a communicating portable electronic device of the agricultural worker, and
a computerized interpretation module associates said temporal zoning data with an agricultural task using said temporal zoning data and said agricultural activity and agricultural exploitation databases,
the computerized interpretation module associates said temporal zoning data with an agricultural task using said temporal zoning data and said agricultural activity and agricultural exploitation databases according to the following:
the computerized interpretation module constructs an image for a determined agricultural parcel from the temporal zoning data and said databases of agricultural activities and agricultural exploitation,
the computerized interpretation module associates the constructed image with an agricultural task carried out in the agricultural parcel using a convolutional neural network.

2. A computerized method according to claim 1, wherein the interpretation module applies at least one of a classifier relating to the agricultural activities defined for the agricultural exploitation and a classifier relating to the agricultural activities defined for a set of agricultural exploitations.

3. A computerized method according to claim 1, wherein:
temporal zoning data of at least one agricultural machine received from a portable electronic device communicating from the agricultural machine are provided, and
the computerized interpretation module associates the temporal zoning data of the agricultural worker to an agricultural task further using temporal zoning data of the agricultural machine.

4. A computerized method according to claim 1, wherein the computerized interpreter module associates the agricultural worker's temporal zoning data with an agricultural task further using weather data relating to the agricultural exploitation obtained from a weather database.

5. A computerized method according to claim 1, further comprising updating the database of agricultural activities from at least the interpreted location data.

6. The method of claim 1 wherein the constructed image comprises a trace formed by the temporal zoning data and at least one geometric primitive parameterized from the temporal zoning data data and said agricultural activity and exploitation databases;
at least one intensity of the image being determined from the temporal zoning data and the agricultural activity and exploitation databases.

7. Method according to claim 1, for which the computerized interpretation module encodes at least one piece of information on one layer of a plurality of layers forming the image;
this at least one piece of information being derived from or deduced from temporal zoning databases and from agricultural activity and agricultural exploitation databases.

8. Method according to claim 7, according to which the at least one piece of information encoded is at least one of:
the trace formed by the temporal zoning data,
the agricultural parcel determined according to the temporal zoning data and the agricultural exploitation database,
a trace of the agricultural parcel,
a previous task carried out in the determined agricultural parcel,
a time elapsed since the last task performed,
a type of agricultural parcel,
a user using the portable system,
a machine using the portable system,
a weather forecast,
an activity carried out on other agricultural exploitations.

9. Method according to claim 1, in which the computerized interpretation module trains the convolutional neural network with images associated with at least one of:
an agricultural task from the database of agricultural activities of an agricultural exploitation of the user or external agricultural exploitations,
an agricultural task entered by the user,
an agricultural task previously determined by the interpretation module.

10. A computer program comprising program code instructions for carrying out the steps of the method according to claim 1 when said program is executed on a computer.

11. Computerized system for interpreting location data of at least one agricultural worker, wherein said computerized system comprises a computerized interpretation module adapted to associate temporal zoning data of at least one agricultural worker received from a portable electronic device communicating from the agricultural worker to an agricultural task by
a database of agricultural activities comprising, for each agricultural activity, a schedule of at least two agricultural tasks, each agricultural task being characterized by a place identifier and a position in the schedule and
an agricultural exploitation database comprising at least one agricultural parcel characterized by a place identifier and a location,
the computerized interpretation module being adapted to associate said temporal zoning data with an agricultural task using said temporal zoning data and said agricultural activity and agricultural exploitation databases according to the following:
the computerized interpretation module constructs an image for a determined agricultural parcel from the temporal zoning data and said databases of agricultural activities and agricultural exploitation,
the computerized interpretation module associates the constructed image with an agricultural task carried out in the agricultural parcel using a convolutional neural network.

12. A computerized system according to claim 11, further comprising at least one communicating portable electronic device of the agricultural worker adapted to communicate temporal zoning data of the agricultural worker to the computerized interpretation module.

13. A computerized system according to claim 11, further comprising a communicating portable electronic device of an agricultural machine adapted to communicate temporal zoning data of the agricultural machine, and in which the computerized interpretation module is adapted to associate temporal zoning data of the agricultural worker further from the temporal zoning data of the agricultural machine.

14. A computerized method according to claim 2, wherein the interpretation module applies a classifier relating to the agricultural activities defined for the agricultural exploitation and a classifier relating to the agricultural activities defined for a set of agricultural exploitations and the interpreting module selects an agricultural task from the results of the two classifiers.
